(19) United States
(12) Patent Application Publication
(10) Pub. No.: US 2026/0087634 A1
(43) Pub. Date: Mar. 26, 2026

(54) ACTIVE WINDOW AND TILE-BASED IMAGE PROCESSING SYSTEMS AND METHODS

(71) Applicant: Apple Inc., Cupertino, CA (US)

(72) Inventors: Jim C Chou, San Jose, CA (US); Sorin C Cismas, Saratoga, CA (US); Ran Hao, San Diego, CA (US); Yun Gong, Cupertino, CA (US)

(21) Appl. No.: 18/896,490

(22) Filed: Sep. 25, 2024

(51) Int. Cl. G06T 7/11; G06T 1/60; G06T 3/40; G06T 3/60

(52) U.S. Cl. CPC G06T 7/11; G06T 1/60; G06T 3/40; G06T 3/60

(57) ABSTRACT

A device may include a display for displaying an image frame based on processed image data and image processing circuitry. The image processing circuitry may process a first tile, of multiple of tiles dividing the image frame, of input image data based on changing a first respective portion of the input image data to generate a first respective portion of the processed image data and process a second tile of the input image data based on changing a second respective portion of the input image data to generate a second respective portion of the processed image data based on a sub-portion of the first respective portion of the input image data.

### BACKGROUND

The present disclosure relates generally to displayed image processing and, more particularly, to utilizing active window and tile-based image processing.

Electronic devices often use one or more electronic displays to present visual information such as text, still images, and/or video by displaying one or more images. For example, such electronic devices may include computers, mobile phones, portable media devices, tablets, televisions, virtual-reality headsets, and vehicle dashboards, among many others. To display an image, an electronic display may control light emission of its display pixels based at least in part on corresponding image data. Moreover, the image data may be processed to account for one or more physical or digital effects associated with displaying the image data. For example, image data may be compensated for pixel aging (e.g., burn-in compensation), cross-talk between electrodes within the electronic device, transitions from previously displayed image data (e.g., pixel drive compensation), warps, contrast control, and/or other factors that may cause distortions or artifacts perceivable to a viewer.

In particular, it may be desirable to change the amount or distribution of the pixel values to account for different display scenarios and/or to alter the pixel values for improved viewing characteristics. For example, image data may be rotated, scaled, and/or warped to change the image data orientation and/or resolution. Moreover, image data may be processed to change the pixel values, such as for color management, dithering, or other image processing techniques. However, performing such image processing efficiently and/or within bandwidth/timing limitations (e.g., for real-time operations) may prove difficult.

### SUMMARY

Image processing circuitry may include a memory-to-memory scaler and rotator (MSR) block to process input image data and adjust the scale, orientation, and/or color/brightness aspects (e.g., color management, contrast control, dithering control, brightness control) of pixel values to provide for the presentation of and/or improve the quality of an output image displayed on an electronic display. In general, the MSR block may receive input image data, such as via direct memory access (DMA), process the image data, and output the processed image data. However, with the increasing resolutions and refresh rates of modern electronics, it may be difficult (e.g., resource and/or time intensive) to process the image data for a full image frame at once. As such, the image processing circuitry may divide the input image frame into a set of multiple tiles and individually process the tiles, such as to make processing more manageable and/or for increased efficiency and/or reduced latency.

In some embodiments, the image processing circuitry (e.g., via the MSR block) may define a set of tiles that encompass the image frame to be displayed and process the tiles. In some embodiments, the output image data determined for each tile may be independent of the output image data of other tiles. The independence of tiles may allow for parallel processing of tiles, such as via multiple MSR sub-blocks. Additionally, in some scenarios, the processed image data may be based on input image data outside the tile boundary. In other words, the MSR block may utilize neighbor input image data (e.g., neighbor data) in addition to the input image data corresponding to the pixel locations of the tile to generate the output pixel values of the processed image data. As such, in some embodiments, the MSR block may overfetch the input image data for each tile, such that each tile may be processed independently of other tiles.

Furthermore, in some scenarios, the portions of the input image data used as neighbor data may also be utilized in the processing of other tiles. As such, in some embodiments, neighbor row buffers and/or neighbor column buffers may be implemented to share the neighbor data between multiple tiles and increase processing speed and efficiency and/or to reduce overfetching. Additionally, by holding neighbor data in neighbor row buffers and/or neighbor column buffers, each of the pixel values of the input image data may be fetched from its source (e.g., image data source via DMA) once, reducing or eliminating repeated fetches of the same data, thus increasing efficiency and/or freeing up DMA for other uses. Additionally, in some embodiments, the neighbor row buffers and/or neighbor column buffers may be populated from fetched portions of the input image data obtained when fetching the input image data for each tile. As such, in some embodiments, while processing the image data to generate the output pixels of the processed image data for a tile may be performed independently of other tiles, the order of data fetching during tile processing may dictate an order of the tile processing.

Additionally, in some embodiments, the tile locations and/or sizes may be based on an active window that specifies pixel locations of an image frame that are to be output (e.g., from the MSR block). For example, the image frame may include pixel locations (e.g., of a pixel grid) that are outside of a display area (e.g., off the edge of an electronic display, behind a border mask of the display, part of a notch of the display) and/or pixel locations associated with image data that is not to be processed (e.g., via the MSR block). To avoid unnecessary processing, the tile locations may be set based on the active window to encompass the active window and not encompass the entirety of the image frame. As should be appreciated, in some scenarios, the active window may include the entire image frame such that the tiles also encompass the entire image frame. Moreover, in some scenarios, the tiles may encompass more than the active window, such as to obtain neighbor data along the edge of the active window, and less than the entire image frame.

### BRIEF DESCRIPTION OF THE DRAWINGS

Various aspects of this disclosure may be better understood upon reading the following detailed description and upon reference to the drawings in which:

FIG. 1 is a schematic diagram of an electronic device that includes an electronic display, in accordance with an embodiment;

FIG. 2 is an example of the electronic device of FIG. 1 in the form of a handheld device, in accordance with an embodiment;

FIG. 3 is another example of the electronic device of FIG. 1 in the form of a tablet device, in accordance with an embodiment;

FIG. 4 is another example of the electronic device of FIG. 1 in the form of a computer, in accordance with an embodiment;

FIG. 5 is another example of the electronic device of FIG. 1 in the form of a watch, in accordance with an embodiment;

FIG. 6 is another example of the electronic device of FIG. 1 in the form of a computer, in accordance with an embodiment;

FIG. 7 is a schematic diagram of the image processing circuitry of FIG. 1 including a memory-to-memory scaler and rotator (MSR) block, in accordance with an embodiment;

FIG. 8 is a schematic diagram of the MSR block of FIG. 7, in accordance with an embodiment;

FIG. 9 is a schematic representation of a portion of an image frame divided into a set of 3×3 tiles with associated neighbor data, in accordance with an embodiment;

FIG. 10 is a schematic representation of a single tile of the set of 3×3 tiles of FIG. 9 with neighbor data therearound, in accordance with an embodiment;

FIG. 11 is a schematic diagram of an example processing order of a set of tiles for a portion of an image frame, in accordance with an embodiment;

FIG. 12 is a timing diagram of an example cascaded processing order of the set of tiles of FIG. 11 over time, in accordance with an embodiment;

FIG. 13 is a schematic diagram of an example parallel architecture of the MSR block of FIG. 7 for implementing the example cascaded processing order of FIG. 11, in accordance with an embodiment;

FIG. 14 is a schematic diagram of an example active window within an image frame defined in a pixel grid, in accordance with an embodiment;

FIG. 15 is a schematic diagram of a tile assignment about an active window within an image frame, in accordance with an embodiment;

FIG. 16 is a flowchart of an example process for utilizing an active window in tile-based image processing, such as via the MSR block of FIG. 7, in accordance with an embodiment;

FIG. 17 is a flowchart of an example process for tile-based image processing utilizing oversampled fetching (e.g., overfetching), in accordance with an embodiment; and

FIG. 18 is a flowchart of an example process for tile-based image processing utilizing cascaded fetching, in accordance with an embodiment.

### DETAILED DESCRIPTION OF SPECIFIC EMBODIMENTS

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

Electronic devices often use electronic displays to present visual information. Such electronic devices may include computers, mobile phones, portable media devices, tablets, televisions, virtual-reality headsets, and vehicle dashboards, among many others. To display an image, an electronic display controls the luminance (and, as a consequence, the color) of its display pixels based on corresponding image data received at a particular resolution. For example, an image data source may provide image data as a stream of pixel data, in which data for each pixel indicates a target luminance (e.g., brightness and/or color) of one or more display pixels located at corresponding pixel positions. In some embodiments, image data may indicate luminance per color component, for example, via red component image data, blue component image data, and green component image data, collectively referred to as RGB image data (e.g., RGB, sRGB). Additionally or alternatively, image data may be indicated by a luma channel and one or more chrominance channels (e.g., YCbCr, YUV), grayscale (e.g., gray level), or other color basis. It should be appreciated that a luma channel, as disclosed herein, may encompass linear, non-linear, and/or gamma-corrected luminance values.

Additionally, the image data may be processed to account for one or more physical or digital effects associated with displaying the image data. For example, image data may be compensated for pixel aging (e.g., burn-in compensation), cross-talk between electrodes within the electronic device, transitions from previously displayed image data (e.g., pixel drive compensation), warps, contrast control, and/or other factors that may cause distortions or artifacts perceivable to a viewer. For example, in some scenarios, the image to be displayed may, if unaltered, appear distorted in orientation, size, color, and/or include image artifacts that reduce the quality of the image being displayed. As such, it may be desirable to change the amount (e.g., resolution, relative sizes, scales) and/or distribution (e.g., shape, rotation, perspective) of the pixel values to account for different display scenarios and/or image characteristics. Furthermore, it may be desirable to adjust the pixel values of image data, such as via color management, contrast control, dithering for increased image quality.

As discussed herein, image processing circuitry may process input image data to adjust the scale, orientation, and/or color aspects (e.g., color management, contrast control, dithering control, brightness control) of pixel values to provide for the presentation of and/or improve the quality of an output image displayed on an electronic display. For example, the image processing circuitry may include a memory-to-memory scaler and rotator (MSR) block to processes the input image data and perform such alterations to the image data. In general, the MSR block may receive input image data, such as via direct memory access (DMA), process the image data, and output the processed image data. However, with the increasing resolutions and refresh rates of modern electronics, it may be difficult (e.g., resource and/or time intensive) to process the image data for a full image frame at once. As such, in some embodiments, the image processing circuitry may divide the input image frame into a set of multiple tiles and individually process the tiles, such as to make processing more manageable. As should be appreciated, while discussed herein in the context of an MSR block, the techniques discussed herein may be applied to different processing blocks performing any suitable types of image processing, such as for increased efficiency and/or reduced latency.

In some embodiments, the image processing circuitry (e.g., via the MSR block) may define a set of tiles that encompass the image frame to be displayed and process the tiles individually. As discussed herein, a tile may be considered as a set of pixels locations corresponding to output pixels of processed image data. In some embodiments, the tiles are non-overlapping such that repeated processing of the same output pixels is reduced or eliminated, thus increasing efficiency. The number of and sizes of the tiles may be determined based on a variety of factors such as but not limited to the size of the image frame, characteristics of the input image data (e.g., grid offsets, image data availability rate), the processing to be accomplished (e.g., scaling rotation, color adaptation), buffer size, and/or latency requirement. For example, a buffer size of a buffer of the MSR block used in processing the tile of image data may limit the size of the tile, and the size of the image frame may dictate a number of tiles to be processed, based on the tile size.

In some embodiments, the tiles may be considered spatial sub-frames that may be independently processed, such as without reliance on processing of other tiles. For example, in some embodiments, the output image data determined for each tile may be independent of the output image data of other tiles. The independence of tiles may allow for parallel processing of tiles, such as via multiple MSR sub-blocks. For example, multiple MSR sub-blocks may process respective tiles in parallel, such as to decrease latency.

Additionally, in some scenarios, the processed image data may be based on input image data outside the tile boundary. For example, color management of pixel values at an edge of a tile boundary may rely on pixel values beyond the edge of the tile for smooth color transitions across the tile boundaries in the processed image data. In other words, the MSR block may utilize neighbor input image data (e.g., neighbor data) in addition to the input image data corresponding to the pixel locations of the tile to generate the output pixel values of the processed image data. As such, in some embodiments, the MSR block may overfetch the input image data for each tile, such that each tile may be processed independently of other tiles.

Furthermore, in some scenarios, the portions of the input image data used as neighbor data may be known when the tile sizes/locations are determined. For example, neighbor data may correspond to portions of input image data along the boundaries of the tiles. As such, in some embodiments, one or more neighbor row buffers and one or more neighbor column buffers may be used to store input image data utilized in the processing of multiple tiles. In some embodiments, the neighbor row buffers and/or neighbor column buffers may be implemented in cache memory for increased processing speed and efficiency. Additionally, by holding neighbor data in neighbor row buffers and/or neighbor column buffers, each of the pixel values of the input image data may be fetched from the its source (e.g., image data source via DMA) once, reducing or eliminating repeated fetches of the same data, thus increasing efficiency and/or freeing up DMA for other uses. Further, in some scenarios, processing of a tile may include fetching a portion of the input image data via DMA. As such, in some embodiments, while processing the image data to generate the output pixels of the processed image data may be performed independently, the order of data fetching may dictate an order of the tile processing.

In some embodiments, the tile locations and/or sizes may be based on an active window that specifies pixel locations of an image frame that are to be output (e.g., from the MSR block). For example, the image frame may include pixel locations (e.g., of a pixel grid) that are outside of a display area (e.g., off the edge of an electronic display, behind a border mask of the display, part of a notch of the display) and/or pixel locations associated with image data that is not to be processed (e.g., via the MSR block). To avoid unnecessary processing, the tile locations may be set based on the active window to encompass the active window and not encompass the entirety of the image frame. As should be appreciated, in some scenarios, the active window may include the entire image frame such that the tiles also encompass the entire image frame. Moreover, in some scenarios, the tiles may encompass more than the active window, such as to obtain neighbor data along the edge of the active window, and less than the entire image frame.

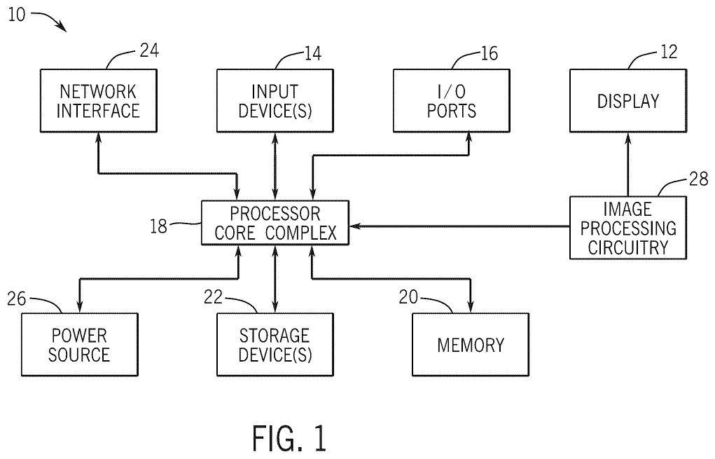

With the foregoing in mind, FIG. 1 is an example electronic device 10 with an electronic display 12 having independently controlled color component illuminators (e.g., projectors, backlights). As described in more detail below, the electronic device 10 may be any suitable electronic device, such as a computer, a mobile phone, a portable media device, a tablet, a television, a virtual-reality headset, a wearable device such as a watch, a vehicle dashboard, or the like. Thus, it should be noted that FIG. 1 is merely one example of a particular implementation and is intended to illustrate the types of components that may be present in an electronic device 10.

The electronic device 10 may include one or more electronic displays 12, input devices 14, input/output (I/O) ports 16, a processor core complex 18 having one or more processors or processor cores, local memory 20, a main memory storage device 22, a network interface 24, a power source 26, and image processing circuitry 28. The various components described in FIG. 1 may include hardware elements (e.g., circuitry), software elements (e.g., a tangible, non-transitory computer-readable medium storing instructions), or a combination of both hardware and software elements. As should be appreciated, the various components may be combined into fewer components or separated into additional components. For example, the local memory 20 and the main memory storage device 22 may be included in a single component. Moreover, the image processing circuitry 28 (e.g., a graphics processing unit, a display image processing pipeline) may be included in the processor core complex 18 or be implemented separately.

The processor core complex 18 is operably coupled with local memory 20 and the main memory storage device 22. Thus, the processor core complex 18 may execute instructions stored in local memory 20 or the main memory storage device 22 to perform operations, such as generating or transmitting image data to display on the electronic display 12. As such, the processor core complex 18 may include one or more general purpose microprocessors, one or more application specific integrated circuits (ASICs), one or more field programmable logic arrays (FPGAs), or any combination thereof.

In addition to program instructions, the local memory 20 or the main memory storage device 22 may store data to be processed by the processor core complex 18. Thus, the local memory 20 and/or the main memory storage device 22 may include one or more tangible, non-transitory, computer-readable media. For example, the local memory 20 may include random access memory (RAM) and the main memory storage device 22 may include read-only memory (ROM), rewritable non-volatile memory such as flash memory, hard drives, optical discs, or the like.

The network interface 24 may communicate data with another electronic device or a network. For example, the network interface 24 (e.g., a radio frequency system) may enable the electronic device 10 to communicatively couple to a personal area network (PAN), such as a Bluetooth network, a local area network (LAN), such as an 802.11x Wi-Fi network, or a wide area network (WAN), such as a 4G, Long-Term Evolution (LTE), or 5G cellular network.

The power source 26 may provide electrical power to operate the processor core complex 18 and/or other components in the electronic device 10. Thus, the power source 26 may include any suitable source of energy, such as a rechargeable lithium polymer (Li-poly) battery and/or an alternating current (AC) power converter.

The I/O ports 16 may enable the electronic device 10 to interface with various other electronic devices. The input devices 14 may enable a user to interact with the electronic device 10. For example, the input devices 14 may include buttons, keyboards, mice, trackpads, and the like. Additionally or alternatively, the electronic display 12 may include touch sensing components that enable user inputs to the electronic device 10 by detecting occurrence and/or position of an object touching its screen (e.g., surface of the electronic display 12).

The electronic display 12 may display a graphical user interface (GUI) (e.g., of an operating system or computer program), an application interface, text, a still image, and/or video content. The electronic display 12 may include a display panel with one or more display pixels to facilitate displaying images. Additionally, each display pixel may represent one of the sub-pixels that control the luminance of a color component (e.g., red, green, or blue). As used herein, a display pixel may refer to a collection of sub-pixels (e.g., red, green, and blue subpixels) or may refer to a single sub-pixel.

As described above, the electronic display 12 may display an image by controlling the luminance output (e.g., light emission) of the sub-pixels based on corresponding image data. In some embodiments, pixel or image data may be generated by an image source, such as the processor core complex 18, a graphics processing unit (GPU), or an image sensor (e.g., camera). Additionally, in some embodiments, image data may be received from another electronic device 10, for example, via the network interface 24 and/or an I/O port 16. Moreover, in some embodiments, the electronic device 10 may include multiple electronic displays 12 and/or may perform image processing (e.g., via the image processing circuitry 28) for one or more external electronic displays 12, such as connected via the network interface 24 and/or the I/O ports 16.

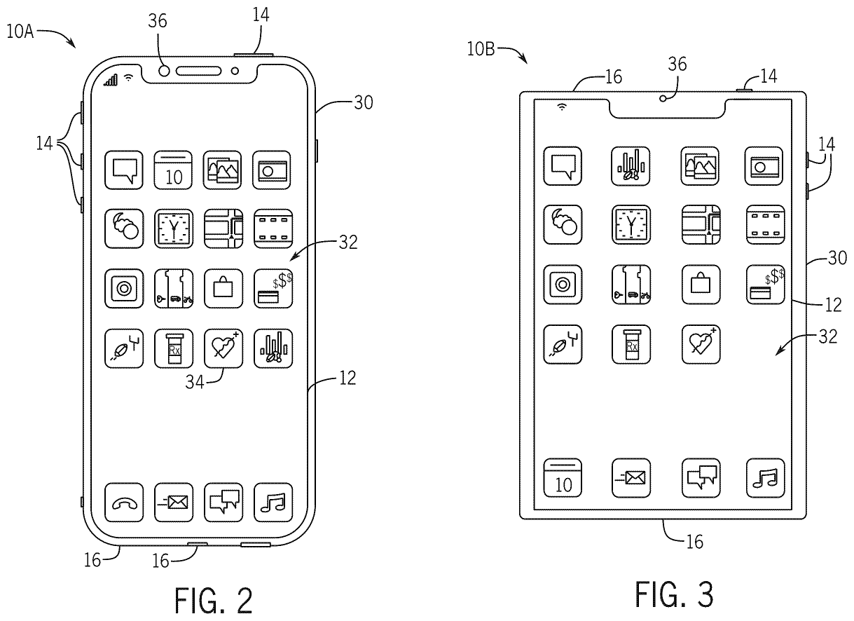

The electronic device 10 may be any suitable electronic device. To help illustrate, one example of a suitable electronic device 10, specifically a handheld device 10A, is shown in FIG. 2. In some embodiments, the handheld device 10A may be a portable phone, a media player, a personal data organizer, a handheld game platform, and/or the like. For illustrative purposes, the handheld device 10A may be a smartphone, such as an IPHONE® model available from Apple Inc.

The handheld device 10A may include an enclosure 30 (e.g., housing) to, for example, protect interior components from physical damage and/or shield them from electromagnetic interference. The enclosure 30 may surround, at least partially, the electronic display 12. In the depicted embodiment, the electronic display 12 is displaying a graphical user interface (GUI) 32 having an array of icons 34. By way of example, when an icon 34 is selected either by an input device 14 or a touch-sensing component of the electronic display 12, an application program may launch.

Input devices 14 may be accessed through openings in the enclosure 30. Moreover, the input devices 14 may enable a user to interact with the handheld device 10A. For example, the input devices 14 may enable the user to activate or deactivate the handheld device 10A, navigate a user interface to a home screen, navigate a user interface to a user-configurable application screen, activate a voice-recognition feature, provide volume control, and/or toggle between vibrate and ring modes. Moreover, the I/O ports 16 may also open through the enclosure 30. Additionally, the electronic device may include one or more cameras 36 to capture pictures or video. In some embodiments, a camera 36 may be used in conjunction with a virtual reality or augmented reality visualization on the electronic display 12.

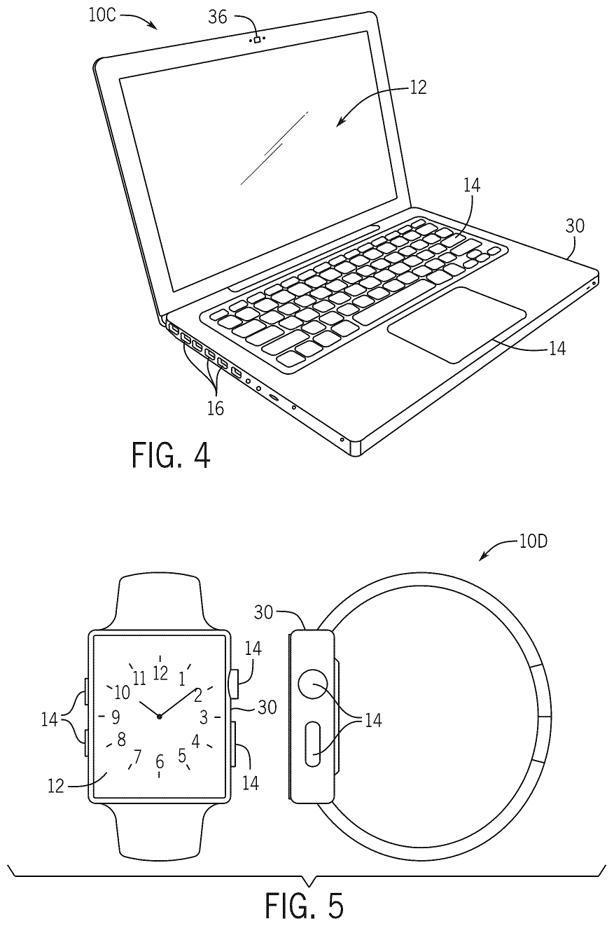

Another example of a suitable electronic device 10, specifically a tablet device 10B, is shown in FIG. 3. The tablet device 10B may be any IPAD® model available from Apple Inc. A further example of a suitable electronic device 10, specifically a computer 10C, is shown in FIG. 4. For illustrative purposes, the computer 10C may be any MACBOOK® or IMAC® model available from Apple Inc. Another example of a suitable electronic device 10, specifically a watch 10D, is shown in FIG. 5. For illustrative purposes, the watch 10D may be any APPLE WATCH® model available from Apple Inc. As depicted, the tablet device 10B, the computer 10C, and the watch 10D each also includes an electronic display 12, input devices 14, I/O ports 16, and an enclosure 30. The electronic display 12 may display a GUI 32. Here, the GUI 32 shows a visualization of a clock. When the visualization is selected either by the input device 14 or a touch-sensing component of the electronic display 12, an application program may launch, such as to transition the GUI 32 to presenting the icons 34 discussed in FIGS. 2 and 3.

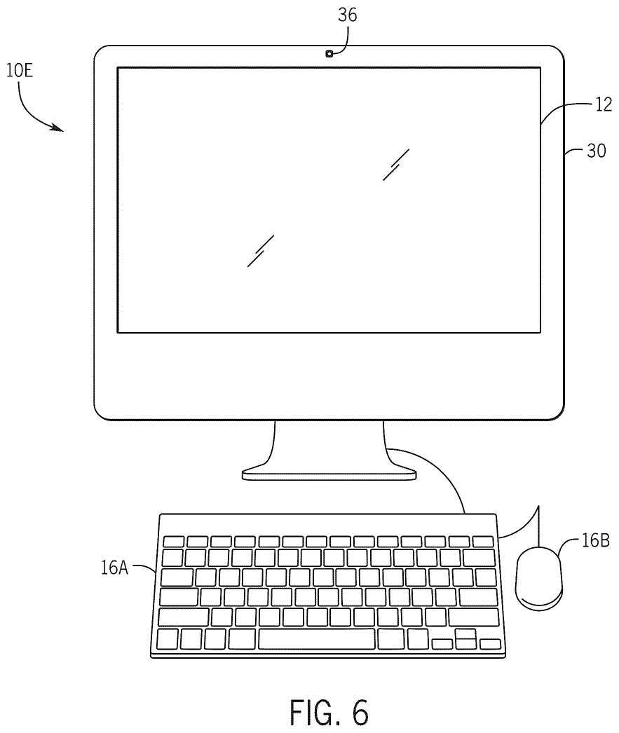

Turning to FIG. 6, a computer 10E may represent another embodiment of the electronic device 10 of FIG. 1. The computer 10E may be any suitable computer, such as a desktop computer, a server, or a notebook computer, but may also be a standalone media player or video gaming machine. By way of example, the computer 10E may be an iMac®, a MacBook®, or other similar device by Apple Inc. of Cupertino, California. It should be noted that the computer 10E may also represent a personal computer (PC) by another manufacturer. A similar enclosure 30 may be provided to protect and enclose internal components of the computer 10E, such as the electronic display 12. In certain embodiments, a user of the computer 10E may interact with the computer 10E using various peripheral input devices 14, such as a keyboard 14A or mouse 14B, which may connect to the computer 10E.

As described above, the electronic display 12 may display images based on image data. Before being used to display a corresponding image on the electronic display 12, the image data may be processed via the image processing circuitry 28. The image processing circuitry 28 may process the image data for display on one or more electronic displays 12. For example, the image processing circuitry 28 may include a display pipeline with hardware and/or software means for processing image data. The image data may be processed by the image processing circuitry 28 to reduce or eliminate image artifacts, compensate for one or more different software or hardware related effects, and/or format the image data for display on one or more electronic displays 12. As should be appreciated, the present techniques may be implemented in standalone circuitry, software, and/or firmware, and may be considered a part of, separate from, and/or parallel with a display pipeline.

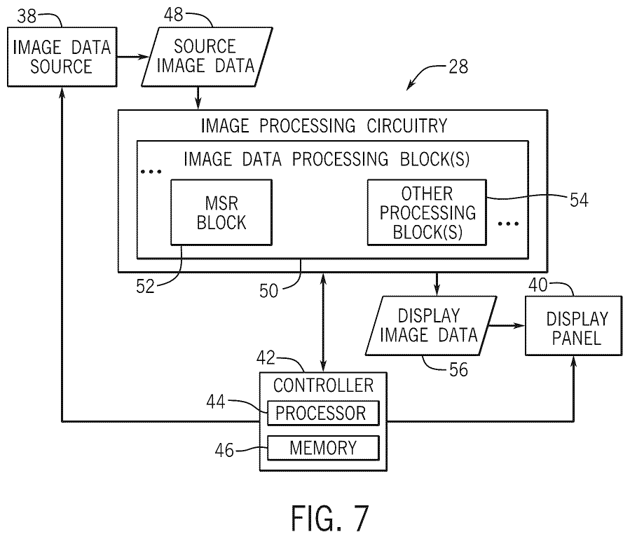

To help illustrate, a portion of the electronic device 10, including image processing circuitry 28, is shown in FIG. 7. The image processing circuitry 28 may be implemented in the electronic device 10, in the electronic display 12, or a combination thereof. For example, the image processing circuitry 28 may be included in the processor core complex 18, a timing controller (TCON) in the electronic display 12, standalone circuitry, or any combination thereof.

The electronic device 10 may also include an image data source 38, a display panel 40, and/or a controller 42 in communication with the image processing circuitry 28. In some embodiments, the display panel 40 of the electronic display 12 may be a reflective technology display, a transmissive technology display such as a liquid crystal display (LCD), a self-emissive technology display such as an organic light emitting diode display (OLED), or any other suitable type of display panel 40. In some embodiments, the controller 42 may control operation of the image processing circuitry 28, the image data source 38, and/or the display panel 40. To facilitate controlling operation, the controller 42 may include a controller processor 44 and/or controller memory 46. In some embodiments, the controller processor 44 may be included in the processor core complex 18, the image processing circuitry 28, a timing controller in the electronic display 12, a separate processing module, or any combination thereof and execute instructions stored in the controller memory 46. Additionally, in some embodiments, the controller memory 46 may be included in the local memory 20, the main memory storage device 22, a separate tangible, non-transitory, computer-readable medium, or any combination thereof.

The image processing circuitry 28 may receive source image data 48 corresponding to a desired image to be displayed on the electronic display 12 from the image data source 38. The source image data 48 may indicate target characteristics (e.g., pixel data) corresponding to the desired image using any suitable source format, such as an RGB format, an αRGB format, a YCbCr format, and/or the like. Moreover, the source image data may be fixed or floating point and be of any suitable bit-depth. Furthermore, the source image data 48 may reside in a linear color space, a gamma-corrected color space, or any other suitable color space. As used herein, pixels or pixel data may refer to a grouping of sub-pixels (e.g., individual color component pixels such as red, green, and blue) or the sub-pixels themselves.

As described herein, the image processing circuitry 28 may operate to process source image data 48 received from the image data source 38. The image data source 38 may include captured images (e.g., from one or more cameras 36), images stored in memory, graphics generated by the processor core complex 18, received images (e.g., via the network interface 24, I/O ports 16, and/or input devices 14) or a combination thereof. Additionally, the image processing circuitry 28 may include one or more sets of image data processing blocks 50 (e.g., circuitry, modules, or processing stages) such as a memory-to-memory scaler and rotator (MSR) block 52. As should be appreciated, multiple other processing blocks 54 may also be incorporated into the image processing circuitry 28, such as a pixel contrast control (PCC) block, color management block, a dither block, a blend block, a burn-in compensation (BIC) block, rotator block, a scaler block, a warp block, etc. before and/or after the MSR block 52. The image data processing blocks 50 may receive and process source image data 48 and output display image data 56 in a format (e.g., digital format, image space, and/or resolution) interpretable by the display panel 40. Further, the functions (e.g., operations) performed by the image processing circuitry 28 may be divided between various image data processing blocks 50, and, while the term “block” is used herein, there may or may not be a logical or physical separation between the image data processing blocks 50. For example, some of the other image processing blocks 54, as set forth above, may be considered as incorporated into the MSR block 52. Moreover, as should be appreciated, although image processing is discussed herein as being performed via a number of image data processing blocks 50, embodiments may include hardware or software components to carry out the techniques discussed herein. Additionally, as should be appreciated, while discussed herein in the context of an MSR block 52, the techniques discussed herein may be applied to any processing blocks 50 performing any suitable types of image processing.

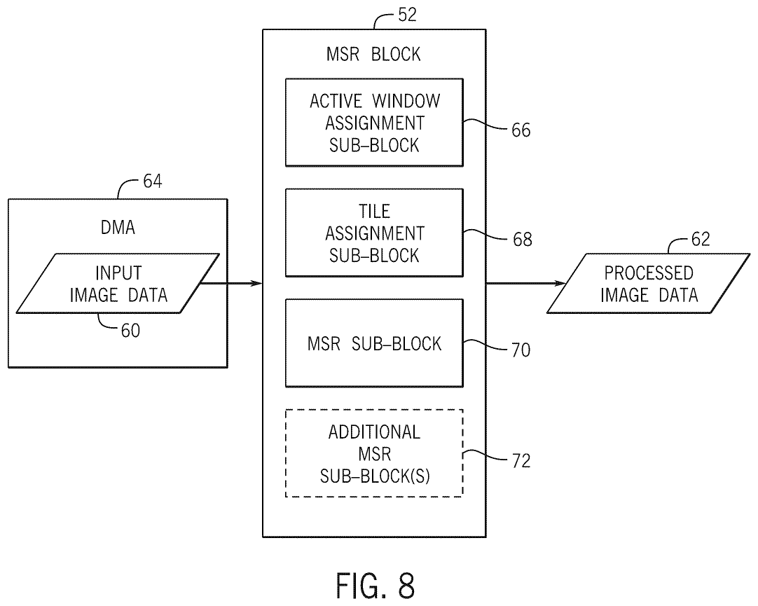

As discussed above, an image to be displayed may, if unaltered, appear distorted when perceived by a viewer in some scenarios. As such, in some embodiments, the MSR block 52 may receive and process input image data 60 and generate processed image data 62, as shown in FIG. 8. As should be appreciated, the input image data 60 may be equivalent to the source image data 48 and/or have been processed, at least partially, by one or more other image processing blocks 54. The MSR block 52 may alter the values of the pixel values of the input image data 60, such as via color management, contrast control, and/or dithering for increased image quality, and/or scale, rotate, or otherwise change the distribution and/or orientation of the pixel values relative to pixel locations of an image frame (e.g., pixel grid).

In some embodiments, the MSR block 52 may fetch the input image data 60 via direct memory access 64 (DMA). As discussed herein, the MSR block 52 may include an active window assignment sub-block 66, a tile assignment sub-block 68, and/or an MSR sub-block 70. Moreover, the MSR block 52 may include additional MSR sub-blocks 72, such as for parallel processing with the MSR sub-block 70. In some embodiments, the MSR block 52 (e.g., via the tile assignment sub-block 68) may perform tile assignments to divide an image frame or active window into discrete pieces for image processing by the MSR sub-block 70. As should be appreciated, while the active window assignment sub-block 66 and tile assignment sub-block 68 are discussed herein as part of the MSR block 52, the assignment of the active window and/or tiles may be performed elsewhere, such as an other processing block 54 or the controller 42 of the image processing circuitry 28.

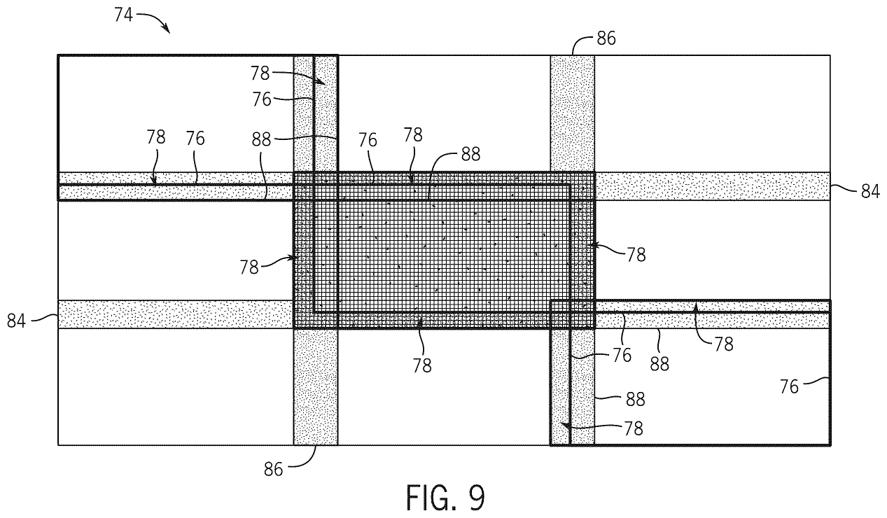

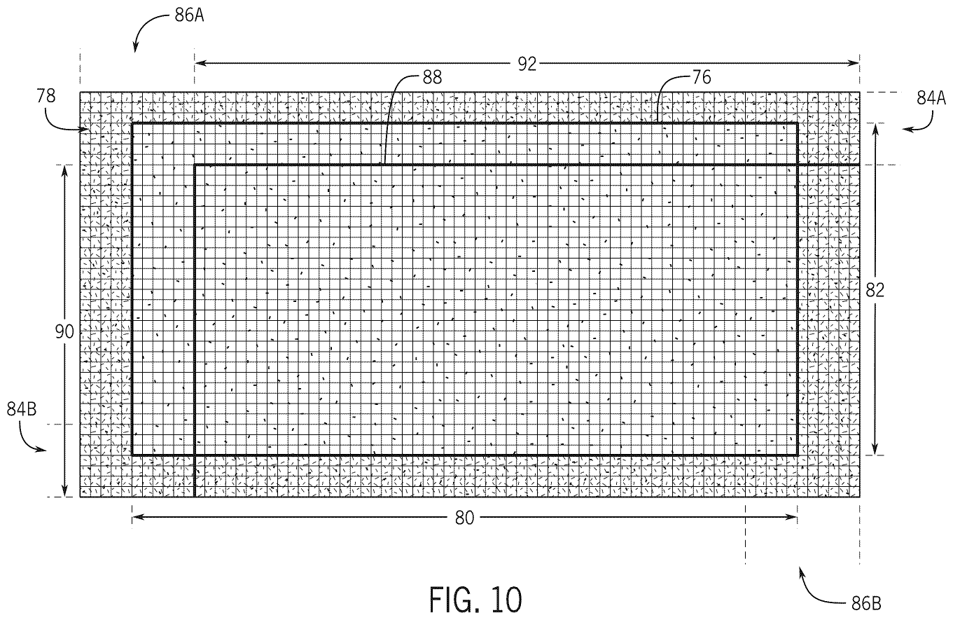

To help illustrate, FIG. 9 is a schematic representation of a portion of an image frame 74 divided into a set of 3×3 tiles 76 with associated neighbor data 78, and FIG. 10 is a schematic representation of a single tile 76 with neighbor data 78 therearound. The tile assignment sub-block 68 may define a set of tiles 76 that encompass the portion of the image frame 74 to be processed. As discussed herein, a tile 76 may be considered as a set of pixels locations corresponding to output pixels of processed image data 62. In some embodiments, the tiles 76 are non-overlapping such that repeated processing of the same output pixels is reduced or eliminated, thus increasing efficiency. The number of and sizes of the tiles 76 may be determined based on a variety of factors such as but not limited to the size of the image frame 74, characteristics of the input image data 60 (e.g., grid offsets, image data availability rate), the processing to be accomplished (e.g., scaling rotation, color adaptation), buffer size, and/or latency requirement. For example, a buffer size of a buffer of the MSR block 52 used in processing a tile 76 of input image data 60 may limit the size of the tile 76 to a tile width 80 and a tile height 82, and the size of the image frame 74 may dictate a number of tiles (e.g., 3×3 in the depicted portion of the image frame 74) to be processed, based on the tile size. Furthermore, in some embodiments, the tile size may be based on a context switch cost (e.g., time and/or computing cost) associated with switching tasks. For example, the tile size may be set such that the processing time of the tile 76 is less than that of a context switch to another task. Additionally, in some embodiments, the tiles 76 may be assigned (e.g., via the tile assignment sub-block 68) such that the sizes of the tiles 76 are the same. Moreover, in some embodiments, a last row and/or last column of tiles 76 may have a different (e.g., smaller) tile height 82 and/or tile width 80, respectively, to account for an end of the image frame 74, active window, and/or set of input image data 60.

In some embodiments, the tiles 76 may be considered spatial sub-frames that may be independently processed, such as without reliance on processing of other tiles 76. For example, in some embodiments, the processed image data 62 determined for each tile 76 may be independent of the processed image data 62 of other tiles 76. The independence of tiles 76 may allow for parallel processing of tiles, such as via the MSR sub-block 70 and one or more additional MSR sub-blocks 72.

In some embodiments, the processed image data 62 for a single tile 76 may be based on the input image data 60 corresponding to the pixel positions within the tile 76 as well outside the tile boundary, discussed herein as neighbor data 78. For example, color management of pixel values at an edge of a tile boundary may rely on pixel values (e.g., neighbor data 78) beyond the edge of the tile 76, and a potentially associated with other tiles 76, for smooth color or brightness transitions across the tile boundaries in the processed image data 62. As such, in some embodiments, the MSR block 52 may overfetch the input image data 60 for each tile 76, such that each tile 76 may be processed independently of other tiles 76. For example, an MSR sub-block 70 may fetch the input image data 60 corresponding to the pixel positions within the tile 76 (e.g., via DMA 64) and at least a portion of the neighbor data 78. Additionally in some embodiments, interdependencies between fetches of the input image data 60 for different tile processing may be introduced to reduce or eliminate overfetching of the input image data 60.

To help further illustrate, in some scenarios, the neighbor data 78 for one tile 76 may correspond to the pixel locations associated with (e.g., within the confines of) other tiles 76. In other words, the MSR block 52 (e.g., via one or more MSR sub-blocks 70) may utilize the same input image data 60 during the processing of multiple different tiles 76. As should be appreciated, the number of pixels of neighbor data 78 on each side of the tile 76 may vary depending on implementation. In some embodiments, the neighbor data 78 may be stored separately and shared between (e.g., utilized in the processing of) multiple tiles 76, to reduce or avoid repeatedly fetching the same input image data 60 (e.g., via DMA 64). For example, in some embodiments, one or more neighbor row buffers 84 and one or more neighbor column buffers 86 may be used to store input image data 60 utilized in the processing of multiple tiles 76. In some embodiments, the neighbor row buffers 84 and/or neighbor column buffers 86 may be implemented in cache memory, such as for increased processing speed and/or efficiency. Additionally, by holding neighbor data 78 in neighbor row buffers 84 and/or neighbor column buffers 86, each of the pixel values of the input image data 60 may be fetched from the its source (e.g., image data source via DMA 64) once, reducing or eliminating repeated fetches of the same data. Furthermore, in some scenarios, the portions of the input image data 60 used as neighbor data 78 may be determined based on the tile sizes and locations. Indeed, the neighbor data 78 within the neighbor row buffers 84 and/or neighbor column buffers 86 may correspond to the portions of input image data 60 along the boundaries of the tiles 76.

The input pixel values 60 associated with each tile 76 may be fetched (e.g., via DMA 64) to a buffer of an MSR sub-block 70 for processing. In some embodiments, the neighbor data 78 for a tile 76 may also be fetched directly to the buffer of the MSR sub-block 70 via DMA 64 for processing of the tile 76. Doing so for each tile 76 may result in overfetching, but also allow for independent processing of the tiles 76, such as in a random order. Alternatively, the neighbor row buffers 84 and/or neighbor column buffers 86 may be populated with the neighbor data 78 of multiple tiles 76 via DMA 64 and the neighbor data 78 may be fetched from the neighbor row buffers 84 and/or neighbor column buffers 86 for use by the MSR sub-block 70. By using the neighbor row buffers 84 and/or neighbor column buffers 86, processing of the tiles 76 may be performed independently, and the MSR sub-block 70 may overfetch from the neighbor row buffers 84 and/or neighbor column buffers 86 with reduced or without repeated use of DMA 64 for the same pixel values. Alternatively, the neighbor row buffers 84 and/or neighbor column buffers 86 may be populated by a cascaded portion of the input image data 60 fetched to populate the buffer of the MSR sub-block 70, which may reduce overfetching.

For example, for the tile 76 depicted in FIG. 10, a fetched portion 88 may be utilized in conjunction with the neighbor data 78 of the left neighbor column buffer 86A and the top neighbor row buffer 84A to generate the processed pixel values of the tile 76. For example, the fetched portion 88 may include the input image data 60 associated with the tile pixel positions and the neighbor data 78 to the right and bottom of the tile 76. Moreover, the fetched portion 88 may be utilized to then populate the right neighbor column buffers 86B and the bottom neighbor row buffers 84B, such as for use with tiles 76 below or to the right. In some embodiments, the fetched height 90 and the fetched width 92 of the fetched portion 88 may be the same as the tile height 82 and the tile width 80. In other words, while processing (e.g., via an MSR sub-block 70) of a portion of the input image data 60 to generate the output pixels of the processed image data 62 for a tile 76 may be performed independently of other tiles 76 (e.g., the processed image data 62 of one tile 76 is independent of the processed image data 62 other tiles 76), in some embodiments, the order of data fetching, which may be related to previous tile processing, may determine the order of future tile processing. As should be appreciated, while discussed herein as processed in certain orders and/or as the fetched portion 88 corresponding to the right neighbor column buffers 86B and the bottom neighbor row buffers 84B, the arrangement (e.g., which pixel locations are associated with the fetched portion) and ordering (e.g., ordering or tile processing) may be varied depending on implementation.

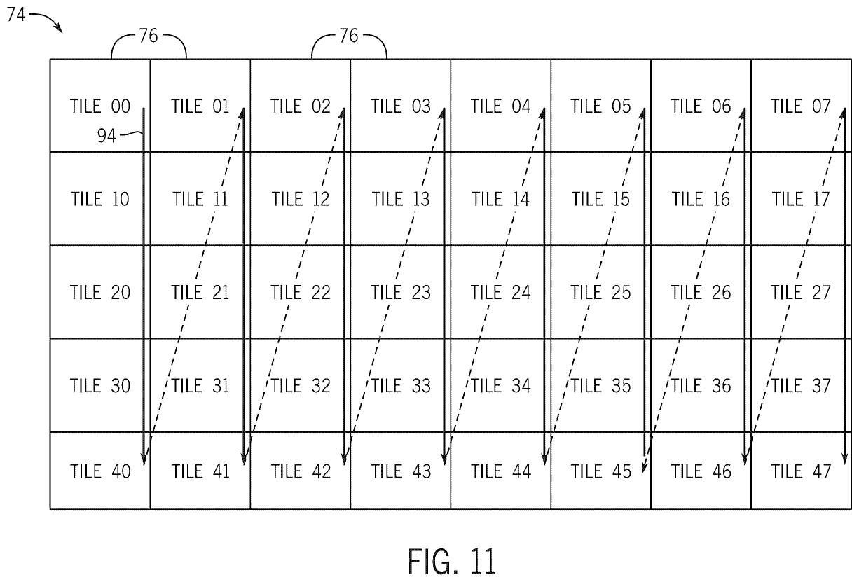

As discussed above, by overfetching the neighbor data 78 around the tiles 76, either directly to the buffer of an MSR sub-block 70 or directly to the neighbor row buffers 84 and/or neighbor column buffers 86, the tiles 76 may be processed independently with regard to timing and output values. As such, in some embodiments, the MSR sub-block 70 and one or more additional MSR sub-blocks 72 may process the tiles in parallel. Alternatively, by populating the neighbor row buffers 84 and/or neighbor column buffers 86 by cascaded portions of a fetched portion 88 of the input image data 60 to the buffer of an MSR sub-block, processing independence may be maintained, but ordering dependency may be established. To help illustrate, FIG. 11 is a schematic diagram of an example processing order 94 of a set of tiles 76 for a portion of an image frame 74. In the depicted example, example processing order 94, the left most column of tiles 76 may be processed first followed by the second column and so on. Indeed, as discussed above, by populating the bottom neighbor row buffer 84B with the neighbor data 78 fetched for processing the first tile 76 (e.g., tile 00), the neighbor data 78 for the tile 76 immediately below the first tile 76 (e.g., tile 76) may be available for processing said tile 76. Similarly, an alternative processing order congruent with the cascaded portions of the fetched portions 88 of the input image data 60 as discussed above may be a raster scan processing order. As should be appreciated, other processing orders may also be apparent given the cascaded fetched portions 88 as discussed above and/or be envisioned with different cascaded fetched portions 88. For example, the fetched portion 88 may include the input image data 60 associated with the tile pixel positions and the neighbor data 78 to the top and/or left of the tile 76, and the processing order may start at the bottom right tile 76 (e.g., tile 47) of the image frame 74 in a reverse raster scan order or the reverse of the example processing order 94.

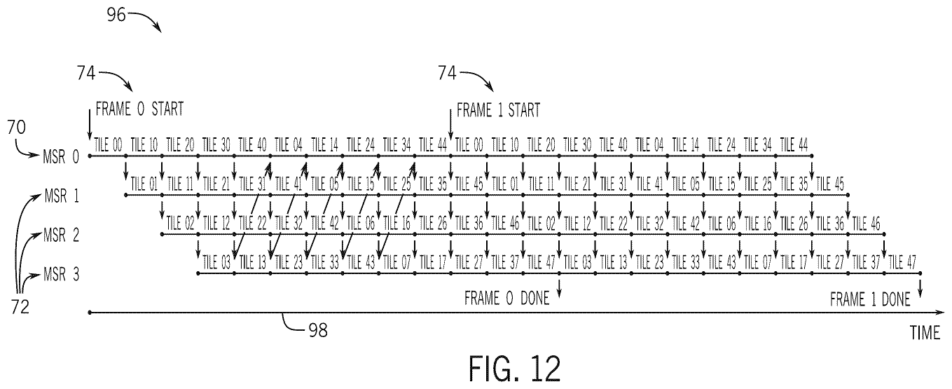

In some embodiments, the example processing order 94 may be accomplished by a single MSR sub-block 70 in series. However, in some embodiments, the cascaded fetched portions 88 may be utilized with a cascaded processing order, such as the example cascaded processing order 96 of FIG. 12, to provide for parallel processing of the MSR sub-block 70 and one or more additional MSR sub-blocks 72. As in the example cascaded processing order 96 shown over time 98, the additional MSR sub-blocks 72 may start processing tiles 76 with a delay when compared to the MSR sub-block 70 to allow for the neighbor data 78 to be written to the neighbor row buffers 84 and/or neighbor column buffers 86 following fetching for the first tiles 76. However, in some embodiments, a cascaded processing order may exhibit a delay for the first image frame 74, but cascade through to the next image frame 74 such that the time between processed image frame outputs is the reduced by overlapping the image frame processing. For example, the MSR sub-block 70 may start processing tiles 76 of the next image frame 74 (e.g., image frame 1), while the additional MSR sub-blocks 72 are still processing tiles 76 of the current image frame 74 (e.g., image frame 0). As with the example processing order 94, as should be appreciated, different cascaded processing orders may be performed, depending on implementation.

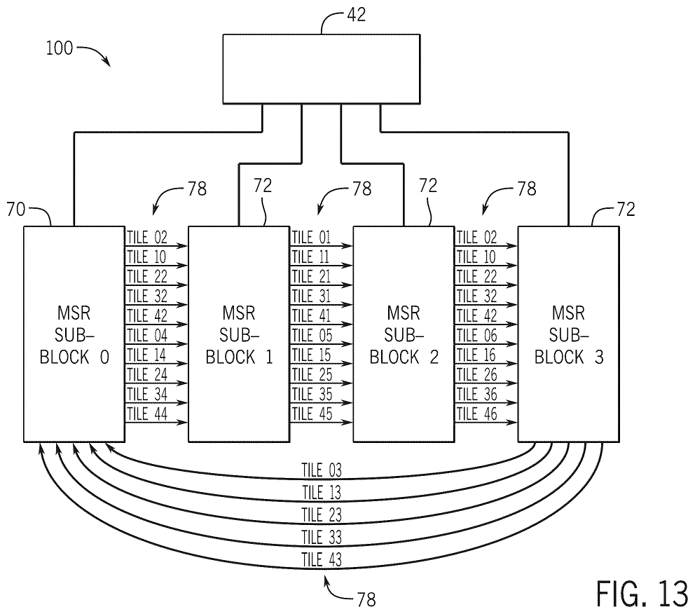

FIG. 13 is a schematic diagram of an example parallel architecture 100 of the MSR block 52 for implementing the example cascaded processing order 96. In the example parallel architecture 100, each MSR sub-block (e.g., 70, 72) may provide the neighbor data 78 for subsequent tile processing to the next MSR sub-block (e.g., 70, 72), such as via the neighbor row buffers 84 and/or neighbor column buffers 86. Additionally, in some embodiments, the controller 42 may control operations of the MSR sub-blocks (e.g., 70, 72 ), such as scheduling of the tile processing. Additionally or alternatively, the MSR sub-blocks (e.g., 70, 72) may provide alerts amongst each other notifying that certain neighbor data 78 is available.

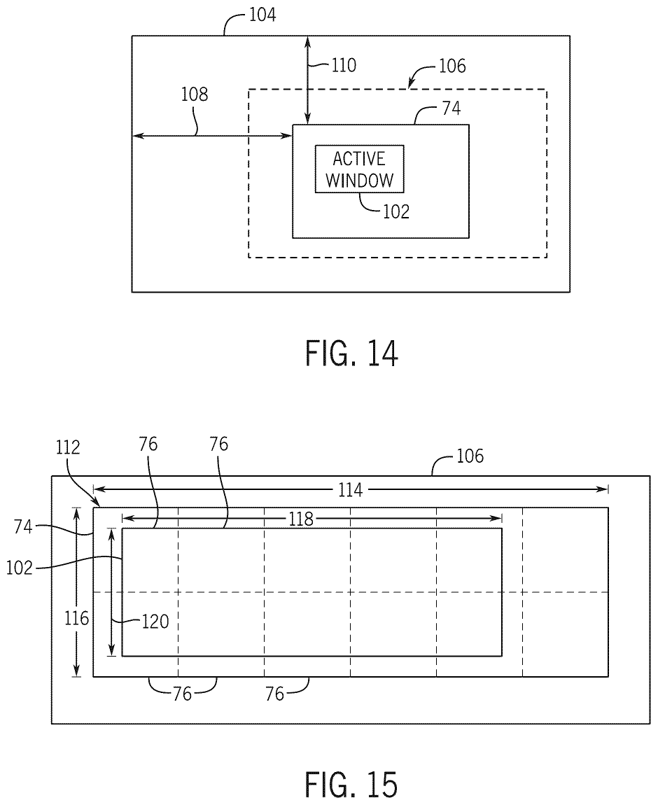

In some embodiments, the tile locations and/or sizes may be based on an active window 102 that specifies pixel locations of an image frame 74 that are to be output and/or processed (e.g., from/by the MSR block 52), as shown in FIG. 14. Indeed, the image frame 74 may include pixel locations (e.g., of an output pixel grid 104) that are outside of a display area (e.g., off the edge of an electronic display, behind a border mask of the display, part of a notch of the display) and/or pixel locations associated with image data that is not to be processed (e.g., via the MSR block 52) or for which different/less processing is to be done, such as a letterbox or static portion of the image frame 74. For example, an input image 106 corresponding to the input image data 60 may correspond to pixel locations of an output pixel grid 104 outside the image frame 74 to be displayed, but such input image data 60 may not be processed as it will not be displayed. As should be appreciated, as discussed herein, the output pixel grid 104 may correspond to a set of addresses (e.g., buffer addresses) for processed image data 62. Moreover, the image frame 74 may be offset relative to the output pixel grid 104 by an x-offset 108 and a y-offset 110.

To reduce image processing to that which will be displayed and/or a portion of the display image data 56 that is to undergo certain processing (e.g., via the MSR block 52), the active window assignment sub-block 66 may assign a position of the active window 102 within the image frame 74. Furthermore, in some embodiments, the tile assignment sub-block 68 may assign tile locations and/or sizes based on the active window 102. To help illustrate, FIG. 15 is a schematic diagram of a tile assignment 112 encompassing an active window 102 within an image frame 74. As should be appreciated, the frame width 114 and frame height 116 of the image frame 74 may be greater than or equal to the window width 118 and/or window height 120, respectively. Indeed, in some scenarios, the active window 102 may include the entire image frame 74, and the tiles 76 may also encompass the entire image frame 74.

Additionally, in some embodiments, the tile locations may be aligned with the active window 102 or be offset with the active window 102. For example, if the active window 102 is aligned with an edge of the input image 106, the tiles 76 may likewise be aligned with the active window 102 and the input image 106, and boundary conditions (e.g., instead of neighbor data 78) may be established along the aligned edge. Furthermore, in some scenarios, the tiles 76 may encompass more than the active window 102, such as to encompass the neighbor data 78 outside the active window 102, as shown in FIG. 15. Additionally, in some embodiments, the tile locations and sizes, relative to the active window 102, may be selected based on the active window location as well such that tile edges are byte aligned (e.g., based on the x-offset 108 and/or y-offset 110) for improved read/write efficiency. As should be appreciated, the input image data 60 may be fetched and the tiles 76 may be processed utilizing any of the above discussed techniques (e.g., overfetching, cascaded fetching, serial or parallel processing). Moreover, in some embodiments, processing of the tiles may be reduced to the portions of the tiles that include the active window 102. For example, portions of the tiles 76 outside the active window 102 may be utilized for neighbor data 78 and not processed to generate process image data 62 for those pixel locations outside the active window 102, which may speed up processing and increase efficiency. Moreover, entire tiles 76 outside the active window 102 may be left unprocessed and/or such pixel locations may not be assigned a tile 76, further improving speed and/or efficiency.

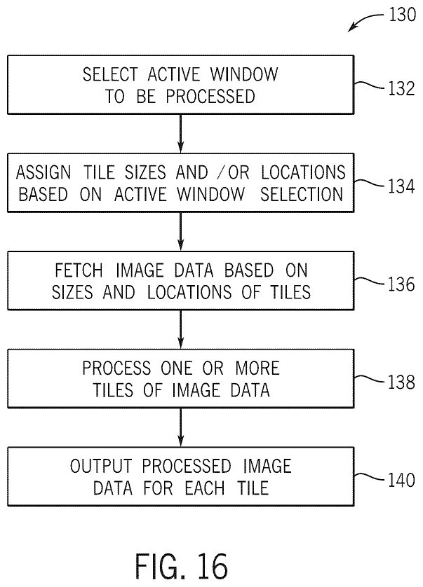

FIG. 16 is a flowchart of an example process 130 for utilizing an active window 102 in tile-based image processing, such as via the MSR block 52. Image processing circuitry 28 (e.g., via an active window assignment sub-block 66) may select an active window 102 to be processed (process block 132). For example, the active window 102 may correspond to pixel locations of an output pixel grid 104 that are to be processed (e.g., via an MSR sub-block 70, 72) for display. Additionally, the image processing circuitry 28 (e.g., via a tile assignment sub-block 68) may assign tile sizes and/or tile locations based on the selection of the active window 102 (process block 134). Input image data 60 may be fetched based on the sizes and locations of the tiles 76 (process block 136), and one or more tiles 76 of the input image data 60 may be processed (process block 138). For example, tiles 76 with input image data 60 within the active window 102 may be processed for color management, contrast control, dithering, scaling, and/or rotating of the input image data 60. Moreover, the processed image data 62 (e.g., corresponding to the active window 102) may be output for each tile 76 (process block 140).

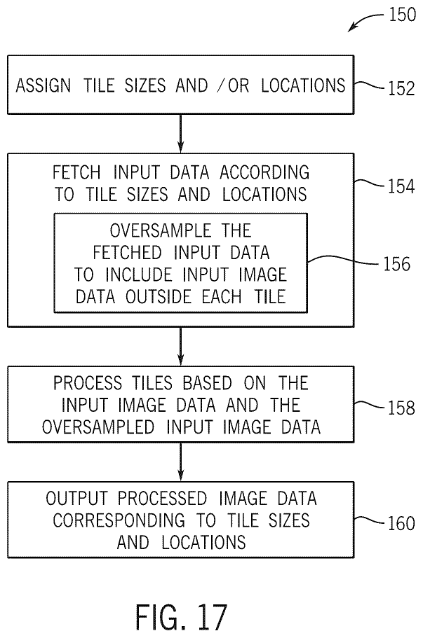

Furthermore, FIG. 17 is a flowchart of an example process 150 for tile-based image processing utilizing oversampled fetching (e.g., overfetching). Image processing circuitry 28 (e.g., via a tile assignment sub-block 68) may assign tile sizes and/or tile locations (process block 152) within an image frame 74. The image processing circuitry 28 may also fetch input image data 60 according to the size and location of a tile (process block 154). The fetching of the input image data 60 for each tile 76 may include oversampling of the fetched input image data 60 to include input image data 60 outside each tile 76 (process block 156), such as neighbor data 78. The image processing circuitry 28 (e.g., via one or more MSR sub-blocks 70, 72) may then process the input image data 60 (e.g., associated with pixel locations of a tile 76) and the oversampled input image data 60 (e.g., the neighbor data 78) (process block 158), to generate processed image data 62 for the tile 76. The processed image data 62 corresponding to the tile size and location may then be output (process block 160).

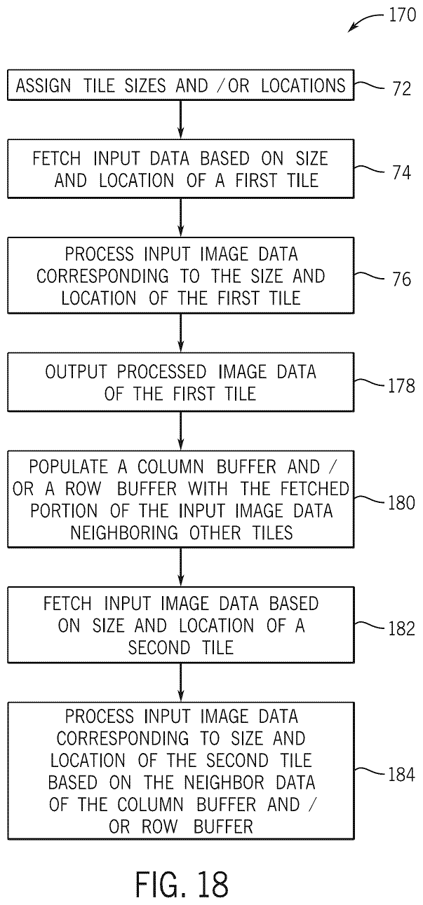

Additionally, FIG. 18 is a flowchart of an example process 170 for tile-based image processing utilizing cascaded fetching. Image processing circuitry 28 (e.g., via a tile assignment sub-block 68) may assign tile sizes and/or tile locations (process block 172) within an image frame 74. Additionally, the image processing circuitry 28 may fetch input image data 60 based on a size and location of a first tile 76 (process block 174) and process (e.g., via an MSR sub-block 70) the input image data 60 corresponding to the size and location of the first tile 76 (process block 176).

As discussed above, the fetched input image data 60 may also include neighbor data 78, such as from a neighbor row buffers 84 and/or neighbor column buffers 86 or from DMA 64. For example, the fetch of the input image data 60 from DMA 64 of the top left tile 76 of FIG. 15 may include the neighbor data 78 for the pixel locations of the processed image data 62 within the active window 102.

Additionally, in some embodiments, the processed image data 62 of the first tile 76 may be output (process block 178) and one or more neighbor row buffers 84 and/or one or more neighbor column buffers 86 may be populated with a portion of the fetched portion 88 of the input image data 60 (e.g., of the first tile 76) that neighbors other tiles 76 (process block 180), discussed herein as neighbor data 78. Further, the image processing circuitry 28 may fetch input image data 60 based on a size and location of a second tile 76 (process block 182) and process the input image data corresponding to the second tile 76 based on the neighbor data 78 of the neighbor column buffers 86 and/or neighbor row buffers 84 (process block 184). Moreover, the processed image data 62 of the second tile 76 may then be output.

As discussed herein the use of a tile based MSR block 52 and/or with the use of an active window 102 may provide for parallel processing, lower latency in generating processed image data 62, reduced fetching via DMA 64 (e.g., such that the input image data 60 is fetched once via DMA 64), and/or increased processing efficiency. Furthermore, although the flowcharts are shown in a given order, in certain embodiments, process blocks may be reordered, altered, deleted, and/or occur simultaneously. Additionally, the flowcharts are given as illustrative tools and further decision and process blocks may also be added depending on implementation.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. A device comprising:
an electronic display configured to display an image frame based on processed image data; and
image processing circuitry configured to:
process a first tile, of a plurality of tiles of the image frame, of input image data based on changing a first respective portion of the input image data to generate a first respective portion of the processed image data; and
process a second tile, of the plurality of tiles, of the input image data based on changing a second respective portion of the input image data to generate a second respective portion of the processed image data based on a sub-portion of the first respective portion of the input image data.

2. The device of claim 1, wherein the image processing circuitry is configured to determine locations of the plurality of tiles relative to the image frame, wherein the plurality of tiles sub-divide the image frame for processing.

3. The device of claim 1, wherein the image processing circuitry is configured to:
fetch the first respective portion of the input image data corresponding to the first tile of the plurality of tiles; and
fetch the second respective portion of the input image data corresponding to the second tile of the plurality of tiles.

4. The device of claim 3, wherein respective portions of the input image data corresponding to the plurality of tiles are fetched from memory only once.

5. The device of claim 3, wherein the image processing circuitry configured to store the sub-portion of the first respective portion of the input image data via one or more buffers for use in processing the second tile.

6. The device of claim 1, wherein the image processing circuitry comprises first memory-to-memory scale and rotate (MSR) circuitry, and wherein processing the first tile comprises scaling, rotating, or scaling and rotating the first respective portion of the input image data corresponding to the first tile via the first MSR circuitry.

7. The device of claim 6, wherein the image processing circuitry comprises second MSR circuitry, and wherein processing the second tile comprises scaling, rotating, or scaling and rotating the second respective portion of the input image data corresponding to the second tile via the second MSR circuitry in parallel with the first MSR circuitry scaling, rotating, or scaling and rotating a third respective portion of the input image data corresponding to a third tile of the plurality of tiles.

8. The device of claim 1, wherein the second tile is adjacent the first tile.

9. The device of claim 1, wherein respective portions of the processed image data of the plurality of tiles do not overlap.

10. Image processing circuitry comprising:
tile assignment circuitry configured to determine locations of a plurality of tiles relative to an image frame; and
memory-to-memory scaler and rotator (MSR) circuitry configured to:
fetch a first respective portion of input image data corresponding to a first tile of the plurality of tiles;
process the first tile to generate a first respective portion of processed image data based on the first respective portion of the input image data;
fetch a second respective portion of the input image data corresponding to a second tile of the plurality of tiles; and
process the second tile to generate a second respective portion of the processed image data based on the second respective portion of the input image data and a sub-portion of the first respective portion of the input image data.

11. The image processing circuitry of claim 10, wherein respective portions of the input image data corresponding to the plurality of tiles are fetched via direct memory access (DMA) only once.

12. The image processing circuitry of claim 11, wherein the image processing circuitry configured to store the sub-portion of the first respective portion of the input image data via one or more neighbor buffers.

13. The image processing circuitry of claim 10, wherein the first respective portion of the input image data comprises neighbor data of the input image data corresponding to pixel locations outside the first tile and along an edge of the first tile, and wherein respective portions of the processed image data of the plurality of tiles do not overlap.

14. The image processing circuitry of claim 10, wherein the MSR circuitry comprises a first MSR sub-block configured to process the first tile and subsequently process the second tile, and where in the MSR circuitry comprises a second MSR sub-block configured to process a third tile in parallel with processing of the second tile via the first MSR sub-block.

15. The image processing circuitry of claim 14, wherein processing the first tile, via the first MSR sub-block, comprises scaling, rotating, or scaling and rotating at least a portion of the first respective portion of the input image data to generate the first respective portion of the processed image data.

16. A non-transitory machine-readable medium comprising instructions, wherein, when executed by one or more processors, the instructions cause the one or more processors to control operations of image processing circuitry or to perform the operations, the operations comprising:
fetching a first respective portion of input image data corresponding to a first tile of a plurality of tiles that span an image frame, wherein tiles the plurality of tiles do not overlap;
processing the first tile to generate a first respective portion of processed image data based on the first respective portion of the input image data;
fetching a second respective portion of the input image data corresponding to a second tile of the plurality of tiles; and
processing the second tile to generate a second respective portion of the processed image data based on the second respective portion of the input image data and a sub-portion of the first respective portion of the input image data fetched for processing of the first tile.

17. The non-transitory, machine-readable medium of claim 16, wherein the operations comprise determining locations or sizes and the locations of the plurality of tiles relative to the image frame.

18. The non-transitory, machine-readable medium of claim 17, wherein the locations or the sizes and the locations are determined based on a latency requirement associated with processing a single tile of the plurality of tiles.

19. The non-transitory, machine-readable medium of claim 16, wherein the operations comprise storing the sub-portion of the first respective portion of the input image data via one or more neighbor buffers.

20. The non-transitory, machine-readable medium of claim 16, wherein the second respective portion of the input image data is greater than the second respective portion of the processed image data, wherein the second respective portion of the input image data comprises neighbor data associated with pixel locations within the first tile, wherein the sub-portion of the first respective portion of the input image data comprises the neighbor data.
